(19) United States
(12) Patent Application Publication
(10) Pub. No.: US 2008/0271259 A1
(43) Pub. Date: Nov. 6, 2008

(54) Solid cleaning composition for imparting bleach resistance to textiles cleaned therewith

(76) Inventor: Daike Wang, Duncan, SC (US)

Correspondence Address: Legal Department (M-495), P.O. Box 1926, Spartanburg, SC, 29304, US

(21) Appl. No.: 11/800,230

(22) Filed: May 4, 2007

(51) Int. Cl. D06M 15/19; C11D 17/06; C11D 3/37

(52) U.S. Cl. 8/115.51; 510/278

(57) ABSTRACT

A powdered cleaning composition containing a particulate polymeric material, methylparaben, an inorganic salt adjuvant, and an aqueous or organic fluid component is provided herein. Such composition not only cleans textile substrates to which it is applied, but also imparts bleach resistance to the cleaned substrate by virtue of the residual composition remaining after cleaning. The present composition and process are particularly useful for cleaning textiles with pile surfaces, such as carpets.

### TECHNICAL FIELD

The present disclosure relates to dry-type cleaning compositions and, in particular, to dry-type cleaning compositions that are especially useful for cleaning textile fabrics, such as pile fabrics. More particularly, the disclosure relates to an improved dry-type cleaning composition, which imparts both soil and bleach resistance to the pile fabrics so cleaned. This composition has been found especially effective at imparting soil and bleach resistance to carpets and other textile articles (for example, rugs, mats, runners, upholstery fabrics, and the like).

### BACKGROUND

Liquid cleaning compositions, such as rug and upholstery shampoos, have long dominated the market for textile cleaning products. Such liquid compositions, however, are generally recognized to suffer from a wide range of significant disadvantages, such as poor efficacy and their tendency to cause color change, shrinking, wicking, and/or matting in the textiles being cleaned. Such compositions, furthermore, tend to produce unwanted deposits in the form of detergent residues on the treated fabric, substantially increasing the resoiling tendency of the fabric. Application of liquid cleaning compositions to textile substrates (such as carpeting) may also require protracted drying times prior to resumption of use of the textile. This required drying time, of course, may prove to be very inconvenient when the fabric is a carpet and where the carpet is, for instance, in a public thoroughfare as would be the case with commercial establishments such as office buildings, theaters, airports, and the like. Additionally, liquid-based cleaning compositions may seep through the textile substrate being cleaned, resulting in the localized saturation of any underlying surface (for example, carpet padding), which may lead to damaging microbial growth.

Because of the foregoing, well-recognized disadvantages associated with the use of liquid cleaning compositions, substantial efforts have been directed to the development of “dry” type cleaning compositions, which are cleaning compositions that will flow and that can be handled as a powder under conditions of intended use. While such compositions may contain considerable amounts of a liquid, such as water and/or organic solvents, in general, the amount of moisture in such compositions is such that the disadvantages typically associated with liquid cleaning compositions, such as drying time requirements, shrinking of the substrates, and discoloration of substrates, are either avoided or minimized.

U.S. Pat. No. 4,434,067 to Malone et al., the disclosure of which is hereby incorporated by reference, describes a dry-type cleaning composition, which contains a particulate polymeric material, an inorganic salt adjuvant, and an aqueous or organic fluid component. This cleaning composition is typically applied to a textile surface, brushed in (for instance, in the case of spot removal), and then removed by vacuuming. It has been found that this cleaning composition, particularly when formed of urea formaldehyde resin particles, is exceptionally good at adsorbing a wide variety of contaminants from textile surfaces.

Despite the advances in cleaning products, many establishments (such as hospitals, nursing homes, residential care facilities, day care centers, and schools) often choose not to install carpet or other textile floor coverings, because of the possibility that cleaning chemicals, such as bleach, may accidentally contact and damage such floor coverings. It would be of benefit to such establishments, in particular, to have a bleach resistant floor covering. Further, it would be especially beneficial to have a renewable treatment for imparting bleach resistance to floor coverings and other textiles. The present disclosure addresses these needs.

Previously, it was discovered that bleach resistance could be imparted to a textile substrate via an aqueous or solvent-based dispersion, which was suitable for incorporation into the process for manufacturing such substrates. Such a process is described in U.S. Pat. No. 5,482,764 to McBride et al., the disclosure of which is hereby incorporated by reference. However, the process for forming such bleach resistant carpets by this method requires creation of a solution of phenolic compounds, which are applied in a manufacturing setting.

Accordingly, the present compositions provide “dry” type, particulate, polymeric cleaning compositions which have high soil removal capacity, which impart excellent resoiling characteristics, and which impart durable bleach resistance, as well as oil and water repellency characteristics, to the fabric substrate that has been cleaned with such compositions. Such compositions are readily used by consumers to maintain facilities, such as schools, health care facilities, residential care facilities, and the like.

### SUMMARY

According to the present invention, a powdered cleaning composition is provided consisting essentially of:
(a) about 100 parts by weight particulate polymeric material having an average particle size of from about 37 to about 105 microns in diameter, an oil absorption value of no less than 40, and a bulk density of at least about 0.2 g/cc;
(b) from about 0.01 to about 75 parts by weight of a bleach resistance-imparting compound (e.g., methylparaben), having an average particle size of from about 1 to about 100 microns in diameter, preferably from about 1 micron to about 10 microns in diameter;
(c) from about 5 to about 400 parts by weight of an inorganic salt adjuvant having an average particle size of from about 45 to about 600 microns in diameter; and
(d) from about 5 to about 400 parts by weight of a fluid consisting essentially of from 0 to 100 percent water containing sufficient surfactant to give a surface tension of less than about 40 dynes per centimeter and from 100 to 0 percent of an organic liquid selected from high boiling hydrocarbon solvents, tetrachloroethylene, methylchloroform, 1,1,2-trichloro-1,2,2-trifluoroethane, an aliphatic alcohol containing from 1 to about 4 carbon atoms, and mixtures thereof.

Also provided herein is a method for imparting bleach resistance and soil resistance to a target textile substrate, the method comprising the steps of:
(a) providing a powdered cleaning composition, the powdered cleaning composition comprising:
   (i) about 100 parts by weight particulate polymeric material having an average particle size of from about 37 to about 105 microns in diameter, an oil absorption value of no less than 40, and a bulk density of at least about 0.2 g/cc;
   (ii) from about 0.01 to about 75 parts by weight of a bleach resistance-imparting compound (e.g., methylparaben), having an average particle size of from about 1 to about 100 microns in diameter, preferably from about 1 micron to about 10 microns in diameter;
   (iii) from about 5 to about 400 parts by weight of an inorganic salt adjuvant having an average particle size of from about 45 to about 600 microns in diameter; and
   (iv) from about 5 to about 400 parts by weight of a fluid consisting essentially of from 0 to 100 percent water containing sufficient surfactant to give a surface tension of less than about 40 dynes per centimeter and from 100 to 0 percent or organic liquid selected from high boiling hydrocarbon solvents, tetrachloroethylene, methylchloroform, 1,1,2-trichloro-1,2,2-trifluoroethane, an aliphatic alcohol containing from 1 to about 4 carbon atoms, and mixtures thereof;
(b) applying, by rubbing, the composition of (a) into a target textile substrate; and
(c) removing substantially all, but not all, of the composition of (a) from the target textile substrate.

### BRIEF DESCRIPTION OF THE DRAWINGS

FIG. 1 is a chart showing the ultraviolet absorption of aliquots taken from different carpet samples, which demonstrates the durability of the present composition over multiple vacuumings.

### DETAILED DESCRIPTION

### Target Substrates

The textile substrate to which the present cleaning composition may be applied is most preferably a carpet or upholstery fabric. As used herein, the term “carpet” is intended to include, without limitation, broadloom carpets, carpet tiles, rugs, mats, and other textile floor covering materials. The carpet may comprise a tufted or bonded substrate and may include cut pile, loop pile, or combinations thereof. The upholstery fabric may be woven, knitted, or nonwoven, or it may be a composite formed of one or more fabric constructions.

The textile substrates may be comprised of natural fibers, synthetic fibers, or combinations thereof. Synthetic fibers include, for example, polyester, acrylic, polyamide, polyolefin, polyaramid, polyurethane, regenerated cellulose, polyvinylacetate, and blends thereof. More specifically, the term “polyester” encompasses polyethylene terephthalate, polybutylene terephthalate, polytriphenylene terephthalate, polylactic acid, and combinations thereof. The term “polyamide” includes, for example, nylon 6; nylon 6,6; and combinations thereof. The term “polyolefin” encompasses, for example, polypropylene, polyethylene, and combinations thereof. The term “polyaramid” includes, for example, poly-p-phenyleneterephthalamid (i.e., KEVLAR® fiber), poly-m-phenylene-terephthalamid (i.e., NOMEX® fiber), and combinations thereof. Natural fibers include, for example, wool, cotton, flax, and blends thereof.

The textile substrate may be formed from fibers or yarns of any size, including microdenier fibers and yarns (that is, fibers or yarns having less than 1 denier per filament). The substrate may be comprised of fibers such as staple fibers, filament fibers, spun fibers, or combinations thereof.

### Composition Components

### (A) Particulate Polymeric Material

A wide variety of synthetic organic polymers may be used to prepare the polymeric particles employed in the present composition. Included among the group of satisfactory polymers are polyurethane, polystyrene, urea-formaldehyde resins, polyvinyl chloride, polyacrylics, polyethylene, polypropylene, acrylonitrile-butadiene-styrene terpolymer, and phenol-formaldehyde resin particles (similar to the type disclosed in French Patent No. 2,015,972, assigned to Henkel Et Co GmbH). Urea-formaldehyde resin polymers, such as those described in U.S. Pat. No. 4,434,067 and U.S. Pat. No. 4,908,149 are preferred.

One potentially preferred particle material for use in the present compositions is the type disclosed in U.S. Pat. No. 4,013,594 to Froelich et al., in which polymeric urea formaldehyde particles were proposed for use in dry cleaning compositions. These particulate urea formaldehyde materials were characterized as possessing a somewhat higher bulk density that previously known urea formaldehyde polymers. Such higher bulk density characteristics are generally believed to result in increased cleaning effectiveness.

In general, the polymeric particles may have a compact, uniform configuration that results in a bulk density of at least about 0.2 g/cc. The bulk density may be determined by conventional techniques, involving weighing a quantity of particles that fill a calibrated container without packing.

The polymeric particles may be characterized by the classical Critical Pigment Volume (CPV) effect, also known as the “oil value” or “oil absorption value.” This value may be determined by ASTM D281, which is described, for example, in U.S. Pat. No. 3,956,162 to Lautenberger. For particles of a certain shape, the oil absorption value is the volume of air between particles. As the air is displaced by a liquid, the flow properties of the powder are reduced until, at the oil absorption value, all of the particles are surrounded by liquid. To remain a flowable powder, the maximum liquid content is restricted to a value below the oil absorption value. Preferably, the absorbent particles have an oil absorption value of at least 40 and, more preferably, of at least 60.

Average particle size of the polymeric particles is preferably from about 35 microns to about 105 microns, as determined by sieve analysis. In general, particle size distribution is preferably such that not more than about 10 percent of the particles are larger than about 105 microns and, in general, not more than about 5 percent of the particles are smaller than about 10 microns.

Particles, which have a size larger than 105 microns, tend to have difficulty penetrating carpet material adequately, and use of such particles typically results in only superficial cleaning at best. Larger particles also have insufficient surface area to absorb a large amount of soil per unit of weight. If the particles are smaller than about 10 microns in diameter, they may adhere to the individual carpet fibers and have a delustering or dulling effect on the color of the carpet. Particles between about 10 and 35 microns may be included in the composition, although they have not been found to contribute to cleaning efficiency to any substantial extent. For this reason, the lower limit for average particle size is preferably in excess of 35 microns.

Particles of satisfactory bulk density, porosity, and size may be obtained by a wide variety of polymerization techniques. Ordinarily, however, the mere grinding of a foamed material to a preferred size may fail to produce a satisfactory product, because such comminuted materials may not have appropriate bulk density and oil absorption characteristics to function satisfactorily.

Certain very tough plastics, such as the terpolymer formed from acrylonitrile, butadiene, and styrene, may be ground to particles having the desired characteristics, because they fracture in a manner that produces particles having many jagged edges and high surface area. Existing techniques of polymerization and insolubilization enable the synthesis of porous particles that are sufficiently porous to take up more than their own weight of oil. According to the preferred preparation, urea and formaldehyde may be polymerized in an acidic aqueous mixture containing a little surfactant to give particles exhibiting a high degree of porosity. Such technique is described in U.S. Pat. No. 2,766,283 to Warden (incorporated by reference), except that a urea/formaldehyde ratio of about 0.91/1.0 is used and the pH of the reaction is maintained at about 1.8.

It is to be understood that the present cleaning composition is not limited to polymeric particles prepared by any particular techinque. Thus, for instance, suspension or precipitation techniques may also be employed with adjustment of conditions to obtain particles of the desired character.

### (B) Particulate Bleach Resistance-Imparting Compound

To enable the present cleaning composition to impart bleach resistance to textiles cleaned therewith, a particulate bleach resistance-imparting compound is added to the cleaning composition. The term “bleach resistance-imparting compound” includes the compounds 2,2-dihydroxy-4,4-dimethoxybenzophenone; salicylamide; salicylic acid; 4-t-butylphenol; 2,4-dihydroxybenzoic acid; methylparaben; and combinations thereof. Preferably, the bleach resistance-imparting compound is methylparaben, because of its performance and because its availability in a food-grade form makes it safe for use around humans and pets. It should be understood that although the bleach resistance-imparting compound will be referred to throughout this disclosure as methylparaben, any of the other compounds listed above may be used instead.

The methylparaben particles are preferably present in an amount of from about 0.01 parts to about 75 parts by weight of the cleaning composition. More preferably, the methylparaben particles are present in an amount of from about 1 part to about 50 parts by weight; most preferably, the methylparaben particles are present in an amount of from about 3 parts by weight to about 10 parts by weight.

The methylparaben particles generally have a smaller diameter than the polymeric material, typically in the range of from about 1 micron to about 500 microns. Preferably, the methylparaben particles have an average particle size of from about 1 micron to about 10 microns.

The addition of methylparaben to the cleaning composition does not affect the appearance of the composition or its cleaning efficacy. Additionally, and importantly, methylparaben does not adversely affect the appearance of the textiles cleaned with the cleaning composition. Finally, methylparaben is non-toxic (especially when using food-grade methylparaben) and poses no threat to humans or animals that may come into dermal contact with a cleaned textile surface.

### (C) Inorganic Salt Adjuvant

The present cleaning composition further includes an inorganic salt adjuvant. The inorganic salt may appropriately be referred to as an adjuvant, because it may aid or modify the action of the principal ingredients of the cleaning composition (that is, the particular polymeric material and fluid component). Such assistance or aid may be accomplished in the form of increased cleaning efficiency, improved soil anti-redepostion properties, and improved oil and water resistance properties of the treated substrate.

A wide variety of inorganic salts may be employed so long as the salt is characterized as having an average particle size of from about 45 to about 600 microns in diameter. Particles of less than about 45 microns may not be used because retrieval problems may occur. Particles of more than about 600 microns may not be used because cleaning efficiency may be adversely affected. Inorganic salts that may advantageously be used include sulfates, chlorides, carbonates (such as calcium carbonate), bicarbonates, borates, citrates, phosphates, nitrates, metasilicates, sorbates, and mixtures thereof. The most preferred inorganic salts are borate salts, although mixtures of sorbates and carbonates have also been used successfully.

The inorganic salt adjuvant is preferably present in an amount of from about 5 to about 400 parts and, more preferably, from about 10 to about 200 parts by weight of the cleaning composition. The parts by weight of inorganic salt that may be employed may include, in addition to the weight of the salt per se, some associated water of hydration. Such water of hydration is defined herein to include all water that cannot be driven off by heating a 1 to 1.5 gram sample to 110° C. for 2 hours.

### (D) Fluid

In preparing the present cleaning compositions, a fluid is incorporated with the polymeric particulate, methylparaben particles, and inorganic salt. The fluid may be (i) water containing sufficient surfactant to lower the surface tension to below about 40 dynes per centimeter, (ii) an organic liquid, or (iii) mixtures of water, surfactant, and organic liquid. Preferably, the fluid is water containing a surfactant.

### Surfactants

Surfactants of a number of classes are satisfactory for use in the present cleaning compositions. The selection of a surfactant is not critical, but the surfactant is preferably capable of lowering the surface tension of the water in the composition to about 40 dynes per centimeter or lower. The surfactant is normally used in amounts ranging from about 0.5% to about 5.0% by weight of the cleaning composition, but useful amounts are not limited to this range.

The surfactant can be a nonionic surfactant or a mixture of a nonionic surfactant and either an anionic surfactant or a cationic surfactant. One potentially preferred composition contains a mixture of from about 1% to about 4% nonionic surfactant.

Representative nonionic surfactants that can be used have the general formula:

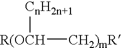

where n is 0 or 1, m is 3 to 20, R′ is OH or OCH₃, and R is C₁₂ to C₂₂ alkyl or phenyl or naphthyl, optionally substituted by C₁ to C₁₀ alkyl groups. One potentially well-suited nonionic surfactant, which may be used alone or in combination with other surfactants, is a difunctional block copolymer surfactant with terminal primary hydroxyl groups, which is sold by BASF under the tradename “PLURONIC® L-62”.

Representative cationic surfactants that can be used are quaternary compounds of the structure [RNR₁R₂R₃]⁺X⁻ where R is C₁₂ to C₂₂ and includes mixtures of alkyls obtained from tallow, hydrogenated tallow, and cocoa; R₁ and R₂ are CH₃, CH(CH₃)CH₂OH, or CH₂CH₂OH; R₃ is CH₃, C₂H₅, or C₆H₅CH₂; and X is Cl, Br, I, or CH₃SO₃.

Preferred anionic surfactants are long chain alcohol sulfate esters, such as those derived from C₁₀-C₁₈ alcohols sulfated with chlorosulfonic acid and neutralized with an alkali. Also preferred are alkylene oxide additives of C₆-C₁₀ mono- and di-esters of orthophosphoric acid.

One particularly satisfactory mixture of commercial anionic surfactants comprises (1) 0.4 percent of the sodium salt of a mixture of C₁₀-C₁₈ alcohol sulfates, predominantly C₁₂, (2) 0.4 percent of the diethylcyclohexylamine salt of the same sulfate mix, and (3) 0.2 percent of the product formed by reacting a mixture of n-octyl mono- and di-esters of orthophosphoric acid with sufficient ethylene oxide to form a neutral product, ordinarily about 2 to 4 moles of ethylene oxide per mole of phosphoric ester.

### Organic Liquids

Organic liquids that may be used as the fluid component include C₁ to C₄ aliphatic alcohols, high boiling hydrocarbon solvents, and high boiling chlorinated hydrocarbon solvents. The hydrocarbon solvents are generally the petroleum distillates with a boiling point between about 100° C. and about 300° C. Organic liquids with a boiling point lower than about 100° C. are generally unsuitable because of their volatility and flammability, and organic liquids with a boiling point higher than about 300° C. do not evaporate from the carpet fibers at a rapid enough rate.

Representative of commercially available hydrocarbon solvents are Stoddard solvent and odorless hydrocarbon solvent. These solvents usually consist of a petroleum distillate with a boiling point of between about 150° C. to 200° C. Properties of these solvents are comparable to those of British Standard White Spirit and domestic Mineral Spirit. Chemically, these solvents consist of a number of hydrocarbons, principally aliphatic, in the decane region. Representative of chlorinated hydrocarbon solvents with high boiling points are perchloroethylene, methylchloroform, and 1,1,2-trichloro-1,2,2-trifluoroethane. The most preferred organic liquid is a hydrocarbon solvent with a relatively high boiling point.

### (E) Optional Additives

The solid cleaning compositions described herein may optionally contain one or more of the following components: vacuum retrieval additives, dust-suppressing additives, static-reducing agents, metal ion chelators, stain resist agents, fragrance, and biocides (used as composition preservatives). Such components may be present in an amount of from about 0.01% by weight to about 5.0% by weight.

Vacuum retrieval additives include, for example, compounds such as polyoxyalkylene materials (e.g., dipropylene glycol), aluminum silicate clay, hydrolyzed styrene maleic anhydride, and mixtures thereof. To suppress dust, polyoxyalkylene materials (e.g., dipropylene glycol) and/or non-volatile organic solvents (e.g., mineral oil) may be used.

One example of a static-reducing agent is aluminum silicate clay. Metal ion chelators include compounds such as ethylene diamine tetraacetic acid (EDTA), for example. Stain resist agents include compounds such as acrylic stain blockers. Biocides, which may be included to prolong the shelf-life of the cleaning composition, include compounds such as potassium sorbate, isothiazolones, and mixtures thereof.

### Composition Formulation

In preparing the present cleaning compositions, best results may be obtained by combining the porous particles with enough of the desired fluid to almost saturate the particles. Thus, it will be seen that a particle with low porosity cannot carry sufficient fluid to produce a composition having the maximum cleaning power. The precise amount of fluid used must be determined by trial and error, but the oil value can serve as a guide to that amount. Particles having low oil values do not require much fluid while those of high porosity, i.e., high oil values, require more fluid. Particles with oil values below 40 typically do not carry sufficient fluid to do a satisfactory textile cleaning job. The optimum amount of fluid varies depending upon the properties of the particular particle. The soil substantivity constant assists in the determination of the optimum amount of fluid that can be used with a given particle type.

The mixing can take place in a customary manner using means apparent to those skilled in the art. Alternatively, the mixing can take place in situ, by feeding the fluid, polymeric particles, methylparaben, and/or inorganic salt adjuvant separately to the textile substrate (e.g., the carpet) and mixing them on the textile (e.g., carpet) fibers.

The minimum proportion of particulate material (that is, polymeric particles, methylparaben, and inorganic salt adjuvant) in the composition is about 105 parts, preferably about 120 parts, per 400 parts by weight of the total composition, as it is difficult to preserve the necessary “dry” character with lower proportions of solid. The fluid portion of the composition may thus form from about 40 parts to about 280 parts of the composition and is preferably from about 80 parts to about 200 parts of the composition, where parts are based upon the total composition weight. Where the cleaning fluid is a mixture of water and solvent, there is no limit on the proportions of each which may be used.

Cleaning compositions as described herein have been found to be very effective for cleaning a wide range of fabric substrates, especially carpet constructions. Cleaning efficiency may be maintained at a very high level, even when fairly large amounts of inorganic salt adjuvant, e.g., up to about 400 parts by weight per 100 parts by weight of particulate polymeric material are provided in the composition.

### EXAMPLE 1

A cleaning composition was created having the following components:

| | |
|---|---|
| Urea formaldehyde resin | 71 parts by weight |
| Methylparaben | 5 parts by weight |
| Carbonate salt | 19 parts by weight |
| Water with PLURONIC ® surfactant | 5 parts by weight |

The components were admixed together to form a fine white powder that was slightly damp to the touch.

### COMPARATIVE EXAMPLE

A cleaning composition was created having the following components:

| | |
|---|---|
| Urea formaldehyde resin | 75 parts by weight |
| Carbonate salt | 20 parts by weight |
| Water with PLURONIC ® surfactant | 5 parts by weight |

The components were admixed together to form a fine white powder that was slightly damp to the touch.

### Evaluation of Bleach Resistance

The cleaning compositions of Example 1 and the Comparative Example were applied to separate, but identical, printed carpet substrate and were removed by vacuuming with a standard, residential vacuum cleaner. It is to be understood that, as with any standard vacuum process, some residual amount of cleaning composition remained in the textile substrate being cleaned. This residue is believed to be responsible for the bleach resistant properties imparted to the textile substrate treated with the Example 1 composition.

Following the removal of the cleaning compositions, 10 grams of undiluted CLOROX®-brand bleach was applied to the carpet substrates in a circular area having a 2-inch diameter. The bleach that was used was a commercially available bleach containing 6.25% hypochlorite. The bleach was allowed to remain on the carpet for 24 hours.

After 24 hours, the carpet samples were observed to determine whether a color change had occurred. The carpet to which the Example 1 composition was applied showed no color change and no visible signs of bleach application. The carpet to which the Comparative Example composition was applied showed a visible, discolored spot in the area of bleach application. In the area where the bleach was applied, the color was faded from the printed carpet substrate.

### Evaluation of Durability of Bleach Resistance

A second evaluation of a number of carpet samples treated with the Example 1 composition (Samples A-E) was conducted to determine the durability of the composition to repeated vacuuming and bleach application. In this evaluation, each of the carpet samples was cleaned with the Example 1 composition by applying the composition to the pile face and brushing into the pile. After application of the composition, the carpet samples were vacuumed with a WINDTUNNEL™ MACH 3 model upright vacuum cleaner manufactured by The Hoover Company, where one pass over the carpet was equated to one “vacuum pass.” A pass in the forward direction followed by a pass in the opposite direction back over the same area equated to two vacuumings or one “vacuuming cycle.”

After certain numbers of vacuuming passes (e.g., 1, 10, 20, 40, etc.), the bleaching process described above was repeated. Specifically, 10 grams of undiluted CLOROX®-brand bleach was applied to the carpet substrates. For subsequent trials, where multiple bleach applications were used, the bleach was applied in the same 2-inch circular area where it was initially applied. For all bleach applications, the bleach that was used was a commercially available bleach containing 6.25% hypochlorite. In each instance, bleach was allowed to remain on the carpet for 24 hours, after which additional vacuuming passes were performed.

The process and results are shown in the table below.

TABLE 1
DURABILITY TESTING

| Step | | No. of Vacuum | |
|---|---|---|---|
| Order | Description of Process Step | Passes | Appearance |
| 1 | Clean entire sample surface with | n/a | Unchanged |
| | Example 1 composition. | | |
| 2 | Vacuum entire sample surface. | 4 | Unchanged |
| 3 | Vacuum entire sample surface. | Sample A: 10 | Unchanged |
| | Begin counting vacuuming passes. | Sample B: 20 | Unchanged |
| | | Sample C: 30 | Unchanged |
| | | Sample D: 40 | Unchanged |
| | | Sample E: 50 | Unchanged |
| 4 | Apply 10 g bleach to 2-inch | n/a | Unchanged |
| | diameter circle on sample surface. | | |
| 5 | Allow sample to dry for 24 hours. | n/a | Unchanged |
| 6 | Cut portion from each Sample | n/a | n/a |
| | (A–E) and submerge face-down | | |
| | in isopropanol for 10 minutes. | | |
| | Take aliquot of isopropanol from | | |
| | sample liquid for evaluation | | |
| | using UV analysis. | | |

In step 6, isopropanol is used to extract methylparaben from the respective samples (A-E). Using UV spectral analysis (e.g, with a UV/vis spectrometer), methylparaben is characterized by a spectral peak at a wavelength of about 258 nanometers.

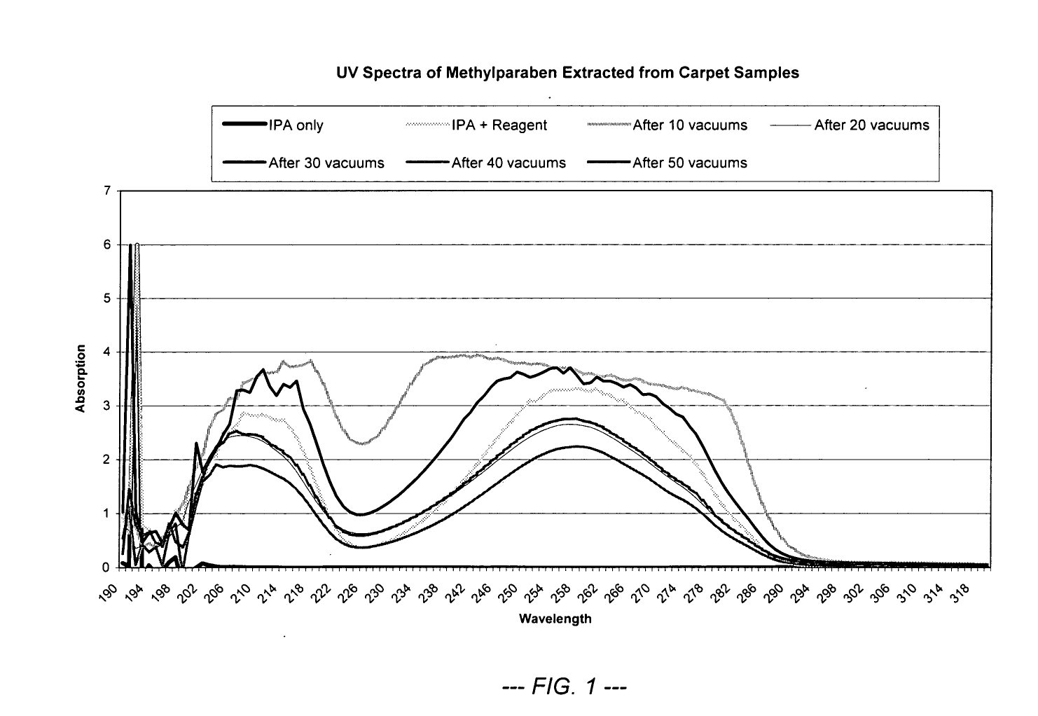

FIG. 1 shows a spectral analysis for each of Samples A-E, as well as (i) a sample of a solution containing only isopropyl alcohol, identified in FIG. 1 as “IPA only”, and (ii) a sample of a solution containing isopropanol and methylparaben, which was created as a reference point and which is identified as “IPA+Reagent”.

For the sample containing only isopropanol and methylparaben, a strong peak is visible at around 258 nanometers. For the sample containing only isopropanol, the spectra is virtually a flat line at 0 absorption at wavelengths greater than about 204 nanometers.

For each of Samples A-E (corresponding to 10-50 vacuuming passes), peaks are visible at around 258 nanometers, indicating the presence of methylparaben, even in those samples that were vacuumed repeatedly and then bleached. Thus, the present composition exhibits considerable durability on a textile surface, making it advantageous for use in a number of different environments from health care facilities to schools to commercial settings.

1. A powdered cleaning composition for cleaning textile substrates and imparting bleach resistance thereto, said cleaning composition consisting essentially of:
(a) about 100 parts by weight particulate polymeric material having an average particle size of from about 37 to about 105 microns in diameter, an oil absorption value of no less than 40, and a bulk density of at least about 0.2 g/cc;
(b) from about 3.0 to about 10 parts by weight of at least one bleach resistance-imparting compound, said bleach resistance-imparting compound having an average particle size of from about 1 to about 100 microns in diameter;
(c) from about 5 to about 400 parts by weight of an inorganic salt adjuvant, said inorganic salt adjuvant having an average particle size of from about 45 to about 600 microns in diameter; and
(d) from about 5 to about 400 parts by weight of a fluid, said fluid consisting essentially of from 0 to 100 percent water containing sufficient surfactant to give a surface tension of less than about 40 dynes per centimeter and from 100 to 0 percent of an organic liquid selected from high boiling hydrocarbon solvents, tetrachloroethylene, methylchloroform, 1,1,2-trichloro-1,2,2-trifluoroethane, an aliphatic alcohol containing from 1 to about 4 carbon atoms, and mixtures thereof.

2. The composition of claim 1, wherein said particulate polymeric material is selected from the group consisting of polyurethane, polystyrene, urea-formaldehyde resins, polyvinyl chloride, polyacrylics, polyethylene, polypropylene, acrylonitrile- butadiene-styrene terpolymer, and phenol-formaldehyde resin particles.

3. The composition of claim 2, wherein said particulate polymeric material is a urea-formaldehyde resin.

4. The composition of claim 1, wherein said bleach resistance-imparting compound is selected from the group consisting of 2,2-dihydroxy-4,4- dimethylbenzophenone; salicylamide: salicyclic acid; 4-t-butylphenol; 2,4- dihydroxybenzoic acid; methylparaben; and combinations thereof.

5. The composition of claim 4, wherein said bleach resistance-imparting compound is methylparaben.

6. The composition of claim 5, wherein said methylparaben has an average particle size of from about 1 micron to about 10 microns in diameter.

7. The composition of claim 1, wherein said inorganic salt adjuvant is selected from the group consisting of sulfates, chlorides, carbonates. bicarbonates, borates, citrates, phosphates, nitrates, metasilicates, sorbates, and mixtures thereof.

8. The composition of claim 7, wherein said inorganic salt adjuvant is a carbonate.

9. The composition of claim 1, wherein said composition further comprises one or more additives selected from the group consisting of vacuum retrieval additives, dust-suppressing additives, static-reducing agents, metal ion chelators, stain resist agents, fragrance, and biocides.

10. A method for imparting bleach resistance and soil resistance to a target textile substrate, the method comprising the steps of:
(a) providing a powdered cleaning composition, the powdered cleaning composition comprising:
(i) about 100 parts by weight particulate polymeric material having an average particle size of from about 37 to about 105 microns in diameter, an oil absorption value of no less than 40, and a bulk density of at least about 0.2 g(cc;
(ii) from about 3.0 to about 10 parts by weight of a bleach resistance-imparting compound, having an average particle size of from about 1 to about 100 microns in diameter
(iii) from about 5 to about 400 parts by weight of an inorganic salt adjuvant having an average particle size of from about 45 to about 600 microns in diameter; and
(iv) from about 5 to about 400 parts by weight of a fluid consisting essentially of from 0 to 100 percent water containing sufficient surfactant to give a surface tension of less than about 40 dynes per centimeter and from 100 to 0 percent or organic liquid selected from high boiling hydrocarbon solvents, tetrachloroethylene, methylchloroform, 1,1,2-trichloro-1,2,2- trifluoroethane, an aliphatic alcohol containing from 1 to about 4 carbon atoms, and mixtures thereof;
(b) applying, by rubbing, said composition of (a) into a target textile substrate; and
(c) removing substantially all, but not all, of said composition of (a) from said target textile substrate.

11. The method of claim 10, wherein said particulate polymeric material is selected from the group consisting of polyurethane, polystyrene, urea-formaldehyde resins, polyvinyl chloride, polyacrylics, polyethylene, polypropylene, acrylonitrile- butadiene-styrene terpolymer, and phenol-formaldehyde resin particles.

12. The method of claim 11, wherein said particulate polymeric material is a urea-formaldehyde resin.

13. The method of claim 10, wherein said bleach resistance-imparting compound is selected from the group consisting of 2,2-dihydroxy-4,4-dimethylbenzophenone; salicylamide; salicyclic acid; 4-t-butylphenol; 2,4-dihydroxybenzoic acid; methylparaben; and combinations thereof.

14. The method of claim 13, wherein said bleach resistance-imparting compound is methylparaben.

15. The method of claim 14, wherein said methylparaben has an average particle size of from about 1 micron to about 10 microns in diameter.

16. The method of claim 10, wherein said inorganic salt adjuvant is selected from the group consisting of sulfates, chlorides, carbonates, bicarbonates, borates, citrates, phosphates, nitrates, metasilicates, sorbates, and mixtures thereof.

17. The method of claim 16, wherein said inorganic salt adjuvant is a carbonate.

18. The method of claim 10 wherein said composition further comprises one or more additives selected from the group consisting of vacuum retrieval additives, dust-suppressing additives, static-reducing agents, metal ion chelators, stain resist agents, fragrance, and biocides.

19. The method of claim 10, wherein said removal of said composition is effectuated by vacuuming.

20. The method of claim 10, wherein said target textile substrate is selected from the group consisting of broadloom carpets, carpet tiles, area rugs, mats, and upholstery fabrics.
